(19) United States
(12) Patent Application Publication
(10) Pub. No.: US 2019/0022535 A1
(43) Pub. Date: Jan. 24, 2019

(54) SYSTEM AND METHODS FOR CREATING AND MANAGING A TEAM-BASED FANTASY SPORTS CONTEST

(71) Applicant: Ronald L. EVANS, Harwich, MA (US)

(72) Inventor: Ronald L. EVANS, Harwich, MA (US)

(21) Appl. No.: 15/653,662

(22) Filed: Jul. 19, 2017

(51) Int. Cl. A63F 13/828; A63F 13/65; A63F 13/46; A63F 13/79; A63F 13/70

(52) U.S. Cl. CPC A63F 13/828; A63F 13/65; A63F 2300/558; A63F 13/79; A63F 13/70; A63F 13/46

(57) ABSTRACT

Systems and methods are provided for creating and managing a season-long fantasy sports contest with team-based tradeable instruments. Each instrument may represent a single team that accumulates points based on the occurrence of team-based events over the course of the season. Each participant may be allocated the same set of instruments at the start of the season with each set including a single instrument for each team in the league. Based on a fixed number of team-based events guaranteed to occur, a pay table may be generated that indicates a pre-determined payout associated with each number of possible points accumulated. At the end of the season, a payout for each participant may be determined based on the pay table and the total number of points associated with the participant's final set of instruments.

### FIELD OF THE INVENTION

This disclosure relates to systems and method for creating and managing a season-long fantasy sports contest with team-based tradeable instruments.

### BACKGROUND OF THE INVENTION

Various types of season-long fantasy sports contests are known. Conventional season-long fantasy sports contests often involve the allocation of each individual player or each team in a league to the participants of the contest, with no individual player or team being initially allocated to, or at any time owned, by more than one participant. In some instances, participants may take turns selecting individual players or teams at the outset of the contest. In other instances, participants may bid on individual players and teams with a limited number of points allocated to them at the outset of the contest. In some conventional season-long fantasy sports contests in which participants possess rights in teams, participants may be allocated dividends upon the occurrence of events associated with those teams.

In each of the foregoing types of conventional season-long fantasy sports contests, each participant begins the contest with a different set of players or teams. As a result, the participants do not begin the contest on a level playing field. Furthermore, the final outcome for each individual participant in the contest is determined based on each participant's accumulation of a number of points derived from various statistics and their performance with respect to other participants.

### SUMMARY OF THE INVENTION

Various embodiments of the present disclosure may include systems and methods for providing a technology platform configured to create and manage a season-long fantasy sports contest with team-based tradeable instruments. Each team-based tradeable instrument may comprise a certificate representing a single team that accumulates points based on the occurrence of team-based events over the course of the season. The team-based events comprise events that are guaranteed to occur over the course of the season. For example, the team-based events may comprise wins, for which a fixed number are guaranteed to occur over the course of the season. Based on the fixed number of team-based events guaranteed to occur, a pay table may be generated that indicates a pre-determined payout associated with each number of possible points accumulated. Each participant in the team-based fantasy sports contest may trade one or more instruments with other participants based on the participant's determination of the likelihood of success for the team represented by each of the one or more instruments. As such, a participant may possess multiple instruments representing the same team based on one or more trades with other participants. At the end of the season, a value (e.g., a number of points) associated with each instrument may be determined and a payout for each participant may be determined based on the pay table and the collective value of the instruments each participant possesses.

In various implementations, a pay table and one or more rules may be stored in association with a team-based fantasy sports contest. For example, the one or more rules may include define who may participate in the contest, whether a fee is required to participate in the contest, the sport and/or league upon which the contest is based, the team-based events that determine the outcome of the contest for each participant, the length of a season, and/or how certificates are to be allocated and traded. In some implementations, one or more participants in each contest may be appointed as an administrative participant who may define one or more rules. For example, one or more rules may be defined based on user input received from a user device associated with an administrative participant.

In various implementations, each participant may be allocated the same set of certificates at the start of the season with each set including a single certificate for each team in the league. In some implementations, each participant may be allocated the set of certificates without having to pay a fee. In some implementations, each participant may be allocated the set of certificates only after paying a fee to participate in the contest. The fee may be predefined by an administrative user, automatically defined based on the sport and/or league upon which the contest is based, defined by one or more participants of the contest, defined by an administrative participant of the contest, and/or otherwise defined.

In various implementations, each participant in the team-based fantasy sports contest may trade one or more instruments with other participants prior to the end of the season. In some implementations, participants may trade one or more certificates for one or more other certificates, one or more points stored in a user account, and/or an amount of real currency or virtual currency stored in a user account. In some implementations, trades may be implemented without payment of a fee. In some implementations, receipt of a fee from one or more participants in the trade may be required to implement the trade.

In various implementations, a value (e.g., a number of points) associated with each instrument (e.g., certificate) may be determined based on the occurrence of one or more team-based events. In various implementations, the instruments may not be redeemed until the end of the season. By comparing the total value of the instruments held by each participant at the end of the season to the pay table generated based on the fixed number of team-based events guaranteed to occur, a payout for each participant may be determined irrespective of the performance of the one or more other participants. The collective value of the payouts may be known in advance based on the fixed number of team-based events guaranteed to occur and the corresponding pay table.

These and other objects, features, and characteristics of the system and/or method disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

Certain features of various embodiments of the present disclosure are set forth with particularity in the appended claims. A better understanding of the features and advantages of the invention(s) will be obtained by reference to the following detailed description that sets forth illustrative embodiments, in which the principles of the invention(s) are utilized, and the accompanying drawings of which:

FIG. 1 depicts a block diagram of an example of a system for creating and managing a team-based fantasy sports contest, in accordance with various embodiments.

FIG. 2 depicts a block diagram of an example of a league administration application, in accordance with various embodiments.

FIG. 3A and FIG. 3B illustrate exemplary pay tables that may be associated with one or more team-based fantasy sports contests, in accordance with various embodiments

FIG. 4 depicts a flowchart of an example method for creating and managing a team-based fantasy sports contest, in accordance with various embodiments

### DETAILED DESCRIPTION OF THE DRAWINGS

The invention described herein relates to systems and methods for providing a technology platform configured to create and manage a season-long fantasy sports contest with team-based tradeable instruments. In various implementations, each team-based tradeable instrument may comprise a certificate representing a single team that accumulates points based on the occurrence of team-based events over the course of the season. Each participant may be allocated the same set of certificates at the start of the season with each set including a single certificate for each team in the league. Based on a fixed number of team-based events guaranteed to occur, a pay table may be generated that indicates a pre-determined payout associated with each number of possible points accumulated. The set of certificates possessed by each participant may be modified during the course of the season based on trades with other participants. At the end of the season, a payout for each participant may be determined based on the pay table and the total number of points associated with the participant's set of certificates.

It will be appreciated by those having skill in the art that the implementations described herein may be practiced without these specific details or with an equivalent arrangement. In various instances, well-known structures and devices are shown in block diagram form to avoid unnecessarily obscuring the implementations.

### Exemplary System Architecture

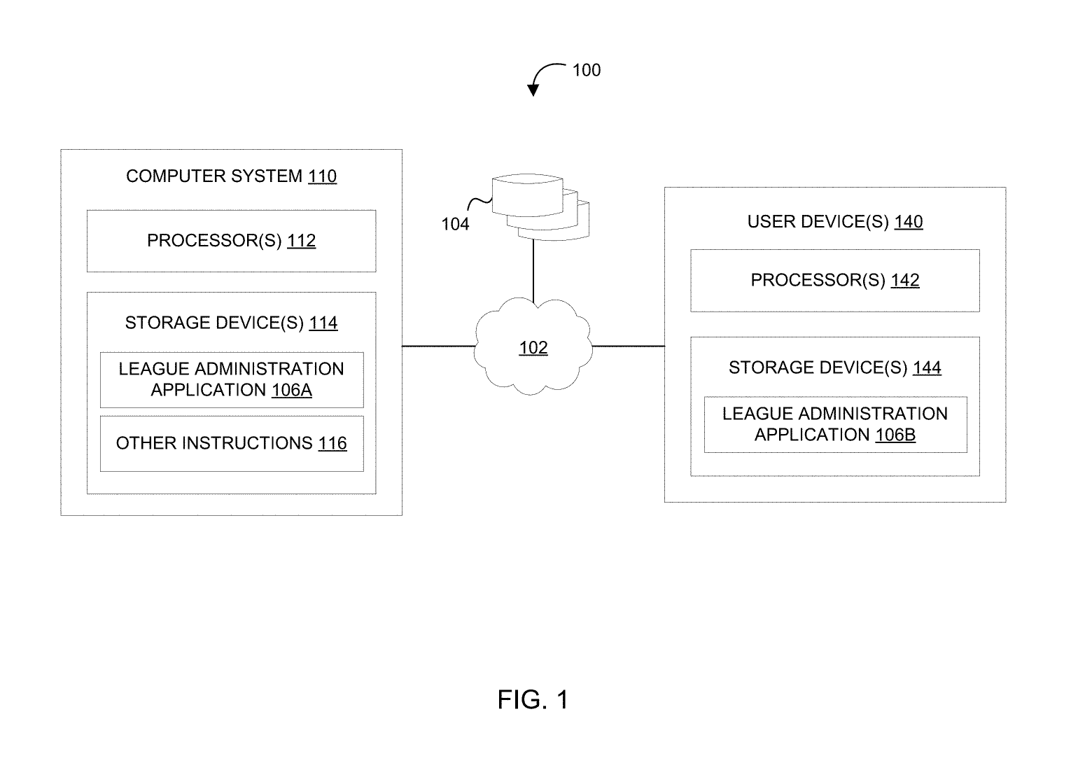

FIG. 1 depicts a block diagram of an example of a system 100 for creating and managing a team-based fantasy sports contest, according to an implementation of the invention. In one implementation, system 100 may include one or more databases 104, a computer system 110, one or more user devices 140, and/or other components.

Computer system 110 may be configured as a server device (e.g., having one or more server blades, processors, etc.), a gaming console, a handheld gaming device, a personal computer (e.g., a desktop computer, a laptop computer, etc.), a smartphone, a tablet computing device, an Internet of Things (IoT) device, a wearable device, and/or other device that can be programmed to create and manage a team-based fantasy sports contest.

Computer system 110 may include one or more processors 112 (also interchangeably referred to herein as processors 112, processor(s) 112, or processor 112 for convenience), one or more storage devices 114, and/or other components. Processors 112 may be programmed by one or more computer program instructions. For example, processors 112 may be programmed by league administration application 106A and/or other instructions 116 that program computer system 110 to perform various operations, each of which are described in greater detail herein. As used herein, for convenience, the various instructions will be described as performing an operation, when, in fact, the various instructions program the processors 112 (and therefore computer system 110) to perform the operation.

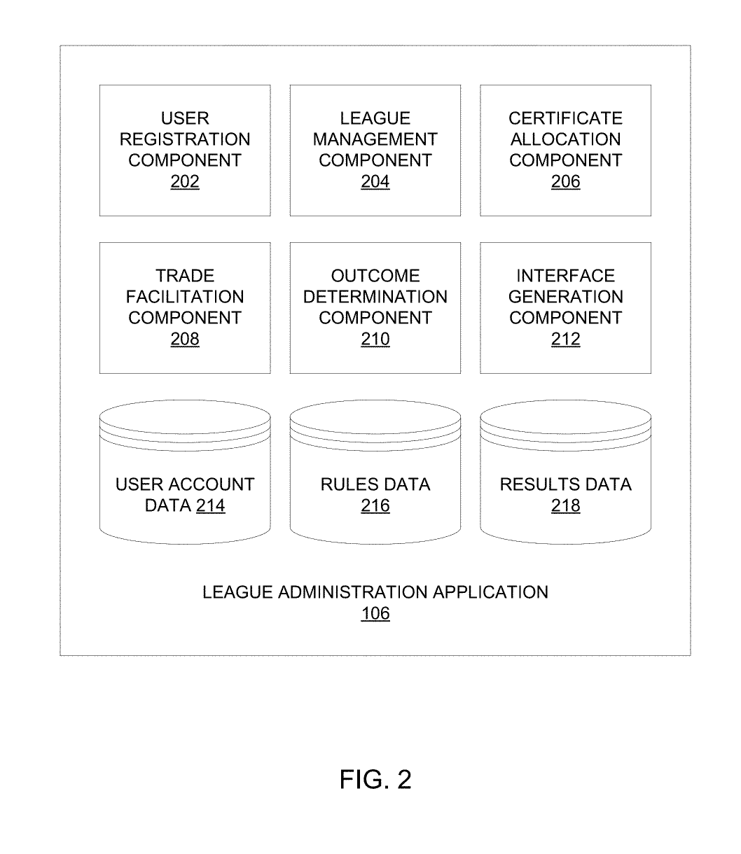

League administration application 106A may program computer system 110 to create and manage a team-based fantasy sports contest using all or a portion of the components of league administration application 106 illustrated in FIG. 2. In other words, computer system 110 may be programmed with some or all of the functions of league administration application 106 described with respect to FIG. 2.

User device(s) 140 (also interchangeably referred to herein as user device 140, user devices 140, or one or more user devices 140 for convenience) may be used by one or more users of system 100. For example, the one or more users of system 100 may include one or more administrative users, one or more participants of a team-based fantasy sports contest, and/or other users associated with the team-based fantasy sports contest. User device(s) 140 may be programmed to interface with computer system 110. In some instances, user device(s) 140 may be programmed to provide identifying information to computer system 110.

User device(s) 140 may be configured as a server device (e.g., having one or more server blades, processors, etc.), a gaming console, a handheld gaming device, a personal computer (e.g., a desktop computer, a laptop computer, etc.), a smartphone, a tablet computing device, an Internet of Things (IoT) device, a wearable device, and/or other device that can be programmed to create and manage a team-based fantasy sports contest.

User device(s) 140 may include one or more processors 142 (also interchangeably referred to herein as processors 142, processor(s) 142, or processor 142 for convenience), one or more storage devices 144, and/or other components. Processors 142 may be programmed by one or more computer program instructions. For example, processors 142 may be programmed by league administration application 106B, and/or other instructions that program the user device(s) 140 to perform various operations, each of which are described in greater detail herein. As used herein, for convenience, the various instructions will be described as performing an operation, when, in fact, the various instructions program the processors 142 (and therefore user device(s) 140) to perform the operation.

League administration application 106B may program one or more users devices 140 to create and manage a team-based fantasy sports contest using all or a portion of the components of league administration application 106 illustrated in FIG. 2. In other words, one or more user devices 140 may be programmed with some or all of the functions of league administration application 106 described with respect to FIG. 2.

Although illustrated in FIG. 1 as a single component, computer system 110 and user device(s) 140 may each include a plurality of individual components (e.g., computer devices) each programmed with at least some of the functions described herein. In this manner, some components of computer system 110 and/or user device(s) 140 may perform some functions while other components may perform other functions, as would be appreciated. The processor(s) 112 and/or processor(s) 142 may each include one or more physical processors that are programmed by computer program instructions. The various instructions described herein are exemplary only. Other configurations and numbers of instructions may be used, so long as the processor(s) 112 and/or processor(s) 142 are programmed to perform the functions described herein.

Furthermore, it should be appreciated that although the various instructions are illustrated in FIG. 1 as being co-located within a single processing unit, in implementations in which processor(s) 112 and/or processor(s) 142 include multiple processing units, one or more instructions may be executed remotely from the other instructions.

The description of the functionality provided by the different instructions described herein is for illustrative purposes, and is not intended to be limiting, as any of instructions may provide more or less functionality than is described. For example, one or more of the instructions may be eliminated, and some or all of its functionality may be provided by other ones of the instructions. As another example, processor(s) 112 and/or processor(s) 142 may be programmed by one or more additional instructions that may perform some or all of the functionality attributed herein to one of the instructions.

The various instructions described herein may be stored in one or more storage devices 114 and/or one or more storage devices 144, which may comprise random access memory (RAM), read only memory (ROM), and/or other memory. The one or more storage devices may store the computer program instructions (e.g., the aforementioned instructions) to be executed by processor(s) 112 and/or processor(s) 142, as well as data that may be manipulated by processor(s) 112 and/or processor(s) 142. The storage device may comprise floppy disks, hard disks, optical disks, tapes, or other storage media for storing computer-executable instructions and/or data.

The various components illustrated in FIG. 1 may be coupled to at least one other component via a network 102, which may include any one or more of, for instance, the Internet, an intranet, a PAN (Personal Area Network), a LAN (Local Area Network), a WAN (Wide Area Network), a SAN (Storage Area Network), a MAN (Metropolitan Area Network), a wireless network, a cellular communications network, a Public Switched Telephone Network, and/or other network. In FIG. 1, as well as in other drawing Figures, different numbers of entities than those depicted may be used. Furthermore, according to various implementations, the components described herein may be implemented in hardware and/or software that configure hardware.

The one or more databases 104 described herein may be, include, or interface to, for example, an Oracle™ relational database sold commercially by Oracle Corporation. Other databases, such as Informix™, DB2 (Database 2) or other data storage, including file-based, or query formats, platforms, or resources such as OLAP (On Line Analytical Processing), SQL (Structured Query Language), a SAN (storage area network), Microsoft Access™ or others may also be used, incorporated, or accessed. The one or more databases 104 may comprise one or more such databases that reside in one or more physical devices and in one or more physical locations. The one or more databases 104 may store a plurality of types of data and/or files and associated data or file descriptions, administrative information, or any other data.

FIG. 2 depicts a block diagram of a league administration application 106 configured to create and manage a team-based fantasy sports contest, according to an implementation of the invention. League administration application 106 may include a user registration component 202, a league management component 204, a certificate allocation component 206, a trade facilitation component 208, an outcome determination component 210, an interface generation component 212, a user account data datastore 214, a rules data datastore 216, a results data datastore 218, and/or other components. One or more of the user registration component 202, league management component 204, certificate allocation component 206, trade facilitation component 208, outcome determination component 210, interface generation component 212, user account data datastore 214, rules data datastore 216, and results data datastore 218 may be coupled to one another or to components not shown in FIG. 2.

User registration component 202 may be configured to register one or more users with system 100. In various implementations, user registration component 202 may be configured to register one or more users with system 100 by creating user accounts for the one or more users. In various implementations, each user account may be associated with a single user that is a participant of one or more fantasy sports contests and may comprise information associated with the user. For example, the information associated with the user may include identifying information (e.g., a first name, a last name, a photo associated with the account, and/or other identifying information), contact information (e.g., a phone number, a mailing address, an email address, a webpage, and/or other contact information), preference information (e.g., contact preferences, newsletter preferences, favorite teams and/or players, preferred rules, and/or other preference information), financial account information, credit card information (e.g., a credit card number, an expiration date, a security code, a billing address, and/or other credit card information), contest participation information (e.g., one or more fantasy sports contests to which the user is a participant, certificates currently or previously associated with the user in one or more fantasy sports contests, an indication of whether the user is an administrative participant in one or more fantasy sports contests, results from one or more previous fantasy sports contests, one or more trades previously implemented involving the user, and/or other contest participation information), account balance information (e.g., a current balance of points, real-world currency, and/or virtual currently owed or associated with the user, and/or other account balance information), and/or other information associated with the user. In various implementations, user registration component 202 may be configured to generate a profile for each user based on the information associated with each individual user. In various implementations, user registration component 202 may be configured to update user accounts and/or profiles for the one or more users.

In various implementations, user registration component 202 may be configured to create and/or update a user account responsive to user input. For example, a user account for a participant may be created and/or updated based on a user input communicating information associated with the participant. In some implementations, user registration component 202 may be configured to create and/or update a user account responsive to user input received via a graphical user interface of one or more user devices 140. In some implementations, user registration component 202 may be configured to create and/or update a user account automatically based on information accessible to system 100. In various implementations, user registration component 202 may be configured to store user accounts in user account data datastore 214.

In various implementations, user registration component 202 may be configured to update a user account based on receipt of payment for additional points. For example, user registration component 202 may be configured to increment an account based on additional points purchased by a user in exchange for a fee. The additional points may be used to enter a league, execute a trade, and/or perform one or more other features of the platform requiring points.

League management component 204 may be configured to associate one or more rules and/or a pay table with season-long, team-based fantasy sports contests. In various implementations, league management component 204 may be configured to establish and/or manage one or more rules associated with a season-long, team-based fantasy sports contest. In various implementations, the one or more rules associated with a contest may indicate that each participant in a contest is to start the season with a set of certificates representing the same set of teams. In various implementations, the one or more rules associated with a contest may indicate that each participant is to start the season with a single certificate representing each team in a league upon which the contest is based. In various implementations, league management component 204 may be configured to determine one or more rules for a contest based on user input received from one or more participants of a contest. In various implementations, league management component 204 may be configured to store one or more rules associated with one or more season-long, team-based fantasy sports contests in rules data datastore 216.

In various implementations, the one or more rules may include rules for allocating a predetermined number of points over the course of the season based on the outcome of a known predetermined number of team-based events during the course of the season. In various implementations, the one or more rules may specify a number of points allocated to each certificate or team per team-based event. For example, the one or more rules may indicate that each win during the regular season is worth one (1) point. In some implementations, team-based events occurring at different points during the season may be worth different point values. For example, the one or more rules may indicate that each win during the regular season is worth one (1) point and that each win during the playoffs is worth two (2) points.

In various implementations, the one or more rules associated with a contest may include one or more rules defining who may participate in the contest, one or more rules defining whether a fee is required to participate in the contest, one or more rules defining the sport and/or league upon which the contest is based, one or more rules defining the team-based events that determine the outcome of the contest for each participant, one or more rules defining the length of a season, one or more rules associated with the allocation of certificates, one or more rules associated with trading certificates, and/or one or more other rules.

In some implementations, the one or more rules defining who may participate in the contest may indicate that a contest may only include a set number of participants. In some implementations, the one or more rules defining who may participate in the contest may indicate that a contest may include a variable number of participants. For example, the one or more rules defining who may participate in the contest may indicate that a contest may include an unlimited number of participants, any number of participants that sign up before a deadline (which may or may not be known by prospective participants), and/or a number of participants that sign up before a deadline (which may or may not be known by prospective participants) up to a predetermined maximum number of participants.

In some implementations, the one or more rules defining whether a fee is required to participate in the contest may indicate that the contest is free to play (i.e., no payment of a fee is required). In some implementations, the one or more rules defining whether a fee is required to participate in the contest may indicate that payment of a fee is required by each participant before each participant may participate in the contest. In some implementations, the one or more rules defining whether a fee is required to participate in the contest may indicate that payment of a single fee is required by one or more of the participants before the one or more participants may participate in the contest. A fee may comprise an number of points (which may or may not be accumulated in a user account of each participant), an amount in real currency, an amount in virtual currency, and/or an amount defined by one or more other forms of payment.

In some implementations, the one or more rules defining the sport and/or league upon which the contest is based may indicate that a contest is based on a single sport. For example, the one or more rules defining the sport and/or league upon which the contest is based may indicate that a contest is based on baseball, basketball, football, hockey, soccer, and/or another sport involving teams. In some implementations, the one or more rules defining the sport and/or league may indicate that the contest is based on an amateur sport, a professional sport, an amateur league, and/or a professional league. In some implementations, the one or more rules defining the sport and/or league upon which the contest is based may indicate that a contest is based on a single league. For example, the one or more rules defining the sport and/or league upon which the contest is based may indicate that a contest is based on Major League Baseball (MLB), the National Basketball Association (NBA), the National Football League (NFL), the National Hockey League (NHL), the English Premier League (EPL), and/or other leagues with a plurality of teams.

In some implementations, the one or more rules defining the team-based events may indicate that the team-based events upon which the contest outcome is based comprise wins, periods lead (e.g., quarters, halves, and/or periods), and/or other team-based events. For example, the team-based events may comprise a win of a game during the course of the season. In various implementations, the team-based events may comprise any event for which a pre-determined number is guaranteed to occur during the course of a single season.

In some implementations, the one or more rules defining the length of a season may indicate that a season includes the pre-season, the regular season, the post-season, and/or one or more rounds of a tournament. In some implementations, the one or more rules may indicate that team-based events occurring during different parts of a season may be worth a different number of points. In some implementations, the one or more rules may indicate that certificates may not be redeemed until the end of the season.

In various implementations, the one or more rules associated with the allocation of certificates may indicate that each participant in a contest is to be allocated the same set of certificates. In various implementations, the one or more rules associated with the allocation of certificates may indicate that each participant in a contest is to be allocated a single certificate representing each team in a league upon which the contest is based. In some implementations, the one or more rules associated with the allocation of certificates may indicate that each participant in a contest is to be allocated a random set of certificates or a predetermined set of certificates.

In some implementations, the one or more rules associated with trading certificates may indicate whether trades may be executed with or without payment of a fee, whether a fee is required to implement a trade, whether approval by an administrative user and/or an administrative participant is required to execute a trade, whether a defined number or percentage of participants must approve a trade before it can be executed, whether all certificates may be traded, whether certain certificates are restricted from being traded during certain time periods, whether trades require a single certificate from each participant, whether trades may be made involving a single certificate from one participant and multiple certificates from the other participant, whether trades may be made involving a single certificate from one participant and a number of points from the other participant, and/or one or more other rules associated with trading certificates.

In some implementations, league management component 204 may be configured to obtain one or more predefined rules from rules data datastore 216. For example, one or more predefined rules may be associated with a sport and/or league. In response to user selection of a particular sport and/or league, league management component 204 may be configured to obtain one or more predefined rules from rules data datastore 216 based on the user selection.

In some implementations, league management component 204 may be configured to automatically determine one or more rules based on information associated with a participant of a contest. For example, league management component 204 may be configured to access user account data datastore 214 to obtain preference information and/or contest participation information for one or more participants of a contest and automatically determine one or more rules for a contest based on the preference information and/or contest participation information.

In various implementations, league management component 204 may be configured to obtain and/or generate a pay table associated with a team-based fantasy sports contest. Pay tables may indicate a pre-determined number of points and/or a pre-determined payout associated with possible numbers of team-based events. For example, a pay table may indicate a pre-determined payout associated with each number of points. In some implementations, a pay table may comprise a point conversion table that indicates the number of points allocated to each certificate and/or team for each occurrence of a team-based event (e.g., a win). In some implementations, a pay table may comprise a dollar payout table that indicates the amount of real currency and/or virtual currency awarded to each participant based on the occurrence of a team-based event (e.g., a win) associated with a certificate associated with the participant. In various implementations, league management component 204 may be configured to store a pay table associated with one or more season-long, team-based fantasy sports contests in rules data datastore 216.

In various implementations, league management component 204 may be configured to obtain a pay table from rules data datastore 216. In some implementations, league management component 204 may be configured to obtain a pre-defined pay table from rules data datastore 216. A pre-defined pay table may comprise a pay table associated with a given sport or league. In some implementations, league management component 204 may be configured to obtain a previously used pay table from rules data datastore 216. For example, league management component 204 may be configured to identify a contest previously participated in by a given participant and obtain the pay table for the previous contest.

In various implementations, league management component 204 may be configured to generate a pay table based on one or more team-based events guaranteed to occur during the course of a season. In some implementations, league management component 204 may be configured to receive a selection of a sport and/or league and a team-based event. Based on the selected sport and/or league and team-based event, league management component 204 may be configured to obtain an indication of a predetermined number of team-based events guaranteed to occur. In some implementations, league management component 204 may be configured to determine the number of team-based events guaranteed to occur. In various implementations, league management component 204 may be configured to generate a pay table, prior to the start of the season, based on the number of team-based events guaranteed to occur.

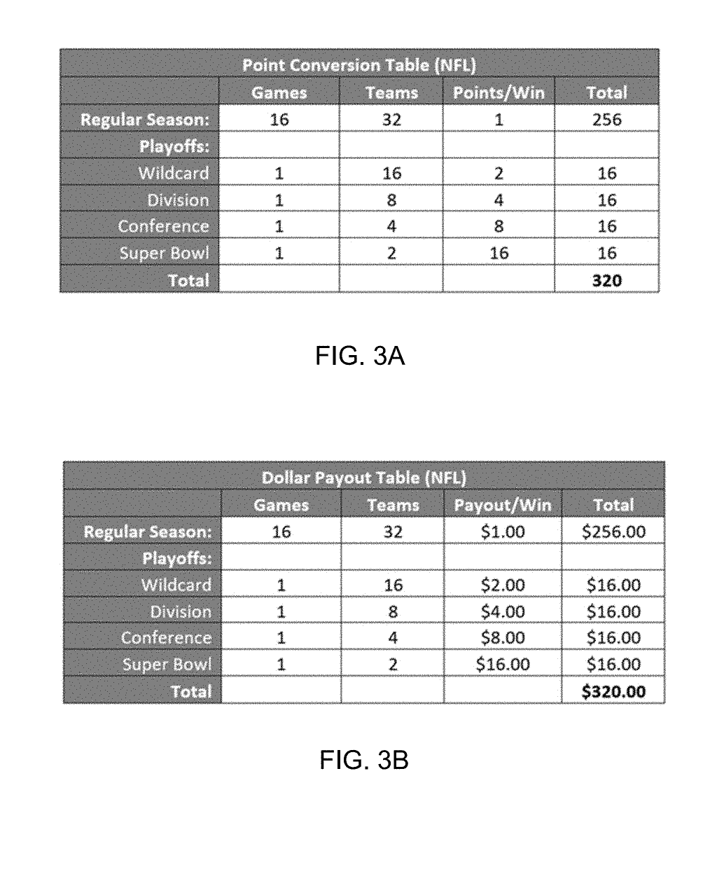

In an exemplary implementation, the selected league may comprise the NFL and the selected team-based event may comprise wins. League management component 204 may be configured to obtain an indication of a fixed number of wins that will occur and/or determine the fixed number of wins that will occur in a single iteration (e.g., a single season) of a team-based fantasy sports contest based on the selection. Referring to FIG. 3A and FIG. 3B, exemplary pay tables that may be associated with one or more team-based fantasy sports contests are depicted. FIG. 3A depicts a point conversion table indicating the number of games occurring during the regular season and playoffs, the number of points to be allocated per win during the regular season and each round of the playoffs, and a total number of wins that are guaranteed to occur during the regular season, each round of the playoffs, and the regular season and playoffs combined. FIG. 3B depicts a dollar payout table indicating number of games occurring during the regular season and playoffs, the payout to be allocated per win during the regular season and each round of the playoffs, and a total payout that is guaranteed to be allocated during the regular season, each round of the playoffs, and the regular season and playoffs combined. Because the contest is based on a team-based events that are guaranteed to occur, a pay table can be defined prior to the start of the season based on the number of team-based events guaranteed to occur.

In various implementations, and referring back to FIG. 2, league management component 204 may be configured to generate a pay table in response to user input. For example, one or more participants of a contest may be able to provide user input used to define a pay table for the contest. In various implementations, league management component 204 may be configured to obtain one or more user inputs received via a graphical user interface displayed on one or more user devices 140. The user input may comprise an indication of a number of points to assign per team-based event, a different number of points to assign per team-based event based on the time of the season in which the team-based event occurs, a payout to be allocated per team-based event, a different payout to be allocated per team-based event based on the time of the season in which the team-based event occurs, and/or other user inputs that may be used to define a pay table for a team-based fantasy sports contest.

In various implementations, league management component 204 may be configured to appoint at least one participant in each contest as an administrative participant. An administrative participant may have access to one or more additional features. Non-administrative participants may not have access to the one or more additional features accessible by administrative participants. The one or more features accessible by the administrative participant of a contest may be predefined by system 100, determined based on the sport and/or league associated with a given contest, determined by the administrative participant, and/or determined based on user input received from one or more participants of a contest. For example, league management component 204 may be configured to communicate a poll to participants of a contest related to additional features accessible by the administrative participant and determine the additional features accessible by the administrative participant based on user feedback received in response to the poll.

In various implementations, league management component 204 may be configured to establish and/or obtain one or more rules for a contest based on user input received from an administrative participant of the contest. For example, league management component 204 may be configured to obtain user input received via a graphical user interface displayed on a user device 140 associated with an administrative participant and define and/or modify one or more rules associated with the contest based on the user input received. In some implementations, league management component 204 may be configured to obtain one or more rules from rules data datastore 216 based on the user input received and information associated with the administrative participant stored in user account data datastore 214.

In various implementations, league management component 204 may be configured to generate and/or obtain a pay table to associate with a contest based on user input received from an administrative participant of the contest. For example, league management component 204 may be configured to obtain user input received via a graphical user interface displayed on a user device 140 associated with an administrative participant and define and/or modify a pay table associated with the contest based on the user input received. In some implementations, league management component 204 may be configured to obtain a pay table from rules data datastore 216 based on the user input received and information associated with the administrative participant stored in user account data datastore 214.

In various implementations, league management component 204 may be configured to create and manage a team-based fantasy sports contest based on the one or more rules. For example, league management component 204 may be configured to communicate the one or more rules to the one or more participants of the contest via a graphical user interface. In various implementations, league management component 204 may be configured to communicate the one or more rules and a pay table associated with a team-based fantasy sports contest to certificate allocation component 206, trade facilitation component 208, outcome determination component 210, and/or interface generation component 212.

Certificate allocation component 206 may be configured to allocate a set of certificates to each participant in a team-based fantasy sports contest prior to or at the start of the season. In various implementations, certificate allocation component 206 may be configured to allocate a fixed number of certificates to each participant in a contest. In various implementations, certificate allocation component 206 may be configured to allocate the same set of certificates to each participant in a contest. In various implementations, certificate allocation component 206 may be configured to allocate a set of certificates to each participant that comprises a single certificate for each team in the sport and/or league upon which the contest is based. For example, in the exemplary implementation in which the league upon which the contest is based comprises the NFL, certificate allocation component 206 may be configured to allocate thirty-two (32) certificates to each participant in the contest, with each of the thirty-two (32) certificates representing one of the thirty-two (32) teams in the NFL.

In some implementations, certificate allocation component 206 may be configured to allocate a different set of certificates to a plurality of participants in a contest. In some implementations, certificate allocation component 206 may be configured to allocate more than one certificate representing a single team to a participant. For example, a single participant may be allocated multiple certificates representing a single team based on bids received from one or more participants for the multiple certificates.

In some implementations, certification allocation component 206 may be configured to allocate a set of certificates to each participant based on one or more bids received from each participant. For example, each certificate may be presented to one or more participants with a solicitation to bid on the certificate. A bid may comprise a number of points, an amount in real currency, an amount of virtual currency, and/or other item(s) of identifiable value that a participant is willing to exchange for the certificate. In some implementations, certification allocation component 206 may be configured to allocate a set of certificates to each participant based on a Dutch auction. For example, certification allocation component 206 may be configured to allocate one or more certificates to a participant by presenting a certificate and incrementally reducing a value (i.e., a price) associated with the certificate until a participant is identified that is willing to exchange the value for the certificate.

In some implementations, certificate allocation component 206 may be configured to allocate the set of certificates to each participant without payment of a fee by each participant. In some implementations, certificate allocation component 206 may be configured to allocate the set of certificates to each participant responsive to payment of a fee by each participant. For example, certificate allocation component 206 may be configured to allocate the set of certificates to each participant responsive to receipt of a number of points, an amount in real currency, an amount in virtual currency, and/or an amount defined by one or more other forms of payment. In some implementations, certificate allocation component 206 may be configured to receive payment of the fee from a user account associated with each participant. For example, certificate allocation component 206 may be configured to decrement a user account associated with each participant based on the number of points, the amount in real currency, and/or the amount of virtual currency in response to receipt of a user input, via a graphical user interface, indicating an assent to pay the fee. In some implementations, the fee may be predefined by an administrative user of system 100, automatically defined based on the sport and/or league upon which the contest is based, defined by one or more participants of the contest, defined by an administrative participant of the contest, and/or otherwise defined.

In various implementations, certificate allocation component 206 may be configured to allocate a set of certificates to each participant based on one or more rules. For example, certificate allocation component 206 may be configured to allocate a set of certificates to each participant based on one or more rules defining whether a fee is required to participate in the contest, one or more rules associated with the allocation of certificates, and/or one or more other rules. In some implementations, certificate allocation component 206 may be configured to obtain the one or more rules from rules data datastore 216 and/or receive the one or more rules from league management component 204.

Trade facilitation component 208 may be configured to implement a trade between participants involving one or more certificates. For example, trade facilitation component 208 may be configured to implement a trade between a first participant of a contest and a second participant of the contest prior to the end of the season. In various implementations, trade facilitation component 208 may be configured to implement a trade between a first participant and a second participant in response to a first indication of assent regarding the trade received from the first participant and a second indication of assent regarding the trade received from the second participant. For example, the first indication and the second indication may comprise user inputs received via a graphical user interface displayed on one or more user devices 140. In various implementations, trade facilitation component 208 may be configured to implement a trade involving one or more certificates associated with a first participant and one or more certificates associated with the second participant. For example, trade facilitation component 208 may be configured to implement a trade involving a first certificate associated with the first participant and a second, different, certificate associated with the second participant. In various implementations, trade facilitation component 208 may be configured to implement a trade involving a first certificate associated with the first participant and a second, different, certificate associated with the second participant by reallocating the first certificate (or a certificate representing the same team as the first certificate) to the second participant and reallocating the second certificate (or a certificate representing the same team as the second certificate) to the first participant.

In various implementations, trade facilitation component 208 may be configured to implement a trade involving a first participant and a second participant in which the first participant trades one or more certificates for a fee received from the second participant. In some implementations, trade facilitation component 208 may be configured to receive payment of the fee from a user account associated with the second participant. For example, trade facilitation component 208 may be configured to decrement a user account associated with the second participant based on the fee amount (e.g., the number of points, the amount in real currency, and/or the amount of virtual currency to be exchanged) in response to receipt of a user input, via a graphical user interface, indicating an assent to pay the fee.

In various implementations, trade facilitation component 208 may be configured to implement a trade involving participants of a contest without payment of a fee by one or more of the participants. In some implementations, trade facilitation component 208 may be configured to implement a trade involving participants of a contest responsive to payment of a fee by one or more of the participants. In some implementations, trade facilitation component 208 may be configured to implement a trade involving participants of a contest responsive to payment of a fee by each of the participants. In some implementations, trade facilitation component 208 may be configured to receive payment of the fee from one or more user accounts associated with the one or more participants involved in the trade.

In various implementations, trade facilitation component 208 may be configured to implement a trade between participants involving one or more certificates based on one or more rules. For example, trade facilitation component 208 may be configured to implement a trade between participants based on one or more rules associated with trading certificates and/or one or more other rules. In some implementations, trade facilitation component 208 may be configured to obtain the one or more rules from rules data datastore 216 and/or receive the one or more rules from league management component 204.

During the course of the season, outcome determination component 210 may be configured to determine an outcome of each team-based event. For example, outcome determination component 210 may determine the number of wins accumulated by each team associated with each certificate. In various implementations, outcome determination component 210 may be configured to determine an outcome of each team-based event in real-time. In various implementations, outcome determination component 210 may be configured to determine a number of points accumulated by each team based on the number of wins accumulated by each team. In various implementations, outcome determination component 210 may be configured to cause the outcomes of each team-based event, information associated with the outcomes of each team-based event, and/or the total number of team-based events associated with each certificate to be displayed via a graphical user interface. For example, the outcome of each-team based event and the total number of team-based events associated with each certificate of a given participant may be displayed via a graphical user interface on one or more user devices 140 associated with the participant. In some implementations, a value for each of one or more certificates may be displayed in association with the one or more certificates. For example, a value determined based on the total number of team-based events associated with each certificate, one or more outcomes involving recent team-based events associated with each certificate, one or more trades involving each certificate, and/or other information associated with each certificate may be displayed in association with each certificate. In some implementations, an indication of the change in the value associated with each certificate may be displayed in association with the certificates. In various implementations, outcome determination component 210 may be configured to store the outcome of each team-based event in results data datastore 218.

In various implementations, outcome determination component 210 may be configured to determine one or more dividends to allocate to participants based on each certificate. For example, a participant may receive a payout based on the value of one or more certificates associated with the participant. In some implementations, the payout may comprise a number of points, an amount in real currency, an amount in virtual currency, and/or another type of payout.

At the end of the season, outcome determination component 210 may be configured to determine an outcome of a team-based fantasy sports contest for each participant. In various implementations, outcome determination component 210 may be configured to determine a number of team-based events allocated to each certificate. For example, outcome determination component 210 may be configured to determine a number of wins accumulated by each team in the league upon which the contest is based. For each win accumulated by a given team in the league, outcome determination component 210 may be configured to allocate a corresponding number of points to the certificate representing the given team. For example, if a given team accumulates eight (8) wins during a season, eight (8) points may be allocated to each certificate associated with the team. In some implementations, outcome determination component 210 may be configured to allocate a different number of points to each certificate based on whether wins by the team represented by the certificate occurred during the regular season or postseason. In various implementations, outcome determination component 210 may be configured to determine, at the end of the season, the number of points allocated to each team based on the outcomes of the team-based events. In various implementations, outcome determination component 210 may be configured to store the number of team-based events allocated to each certificate in results data datastore 218.

In various implementations, outcome determination component 210 may be configured to identify a final set of certificates associated with each participant. In various implementations, the final set of certificates associated with each participant may be different based on one or more trades between the one or more participants of the team-based fantasy sports contest. In various implementations, outcome determination component 210 may be configured to determine a total number of points associated with the final set of certificates of each participant. In various implementations, outcome determination component 210 may be configured to store an indication of the final set of certificates and/or a total number of points associated with the final set of certificates for each participant in a user account associated with each participant in user account data datastore 214 and/or in association with the contest in results data datastore 218.

In various implementations, outcome determination component 210 may be configured to determine a value of a payout for each participant based on the total number of points associated with the final set of certificates of each participant of the contest and a pay table associated with the contest. In various implementations, outcome determination component 210 may be configured to cause an account of one or more participants to be credited based on the determined payout. For example, outcome determination component 210 may be configured to credit a user account of a first participant based on the payout determined at the end of the season. In various implementations, outcome determination component 210 may be configured to communicate with user account data datastore 214 to update an account of a participant based on a payout determined for the participant at the end of the season.

Interface generation component 212 may be configured to generate and manage a user interface presented via a graphical user interface. In various implementations, interface generation component 212 may be configured to cause a user interface to be displayed via one or more user device 140. In various implementations, the user interface may comprise an online interface. In various implementations, interface generation component 212 may be configured to enable the receipt of user input via the user interface. In some implementations, interface generation component 212 may be configured to generate and manage an administrative user interface, an administrative participant interface, a participant interface, and/or one or more other interfaces related to an administration of the team-based fantasy sports contest. In some implementations, interface generation component 212 may be configured to store one or more rule-based permissions in association with one or more interfaces. For example, interface generation component 212 may be configured to restrict access to an administrative user interface only to administrative users, restrict access to an administrative participant interface to administrative participants, and/or restrict access to a participant interface associated with a fantasy sports contest to participants of the fantasy sports contest.

User account data datastore 214 may be configured to store user account data for one or more users registered with system 100. In various implementations, user account data for each user may comprise information associated with the user. For example, the information associated with the user may include identifying information, contact information, preference, financial account information, credit card information, contest participation information, account balance information, and/or other information associated with the user. In various implementations, user account data for each user may comprise a profile of the user generated based on and/or comprising the information associated with the user.

Rules data datastore 216 may be configured to store one or more rules and/or a pay table associated with each active and/or inactive fantasy sports contest. In various implementations, the one or more rules may include rules for allocating a predetermined number of points over the course of the season based on the outcome of a known predetermined number of team-based events during the course of the season. In various implementations, the pay table may indicate a pre-determined number of points and/or a pre-determined payout associated with possible numbers of team-based events. For example, a pay table may indicate a pre-determined payout associated with each number of total points. In some implementations, rules data datastore 216 may be configured to store one or more predefined rules and/or a predefined pay table associated with a predefined contest and/or associated with a sport and/or league.

Results data datastore 218 may be configured to store an outcome of each team-based event, information associated with the outcome of each team-based event, information associated with the outcome of each team-based event, the number of team-based events accumulated by each team, the number of team-based events and/or points allocated to each certificate, a record of each trade implemented, an indication of the final set of certificates associated with each participant in one or more contests, an indication of the total number of points associated with the final set of certificates associated with each participant in one or more contests, and/or other information related to one or more fantasy sports contests. Information associated with the outcome of each team-based event may comprise the final score of the game, the teams involved, individual statistics, team statistics, and/or other information related to the outcome of a team-based event.

### Exemplary Flowchart of Process

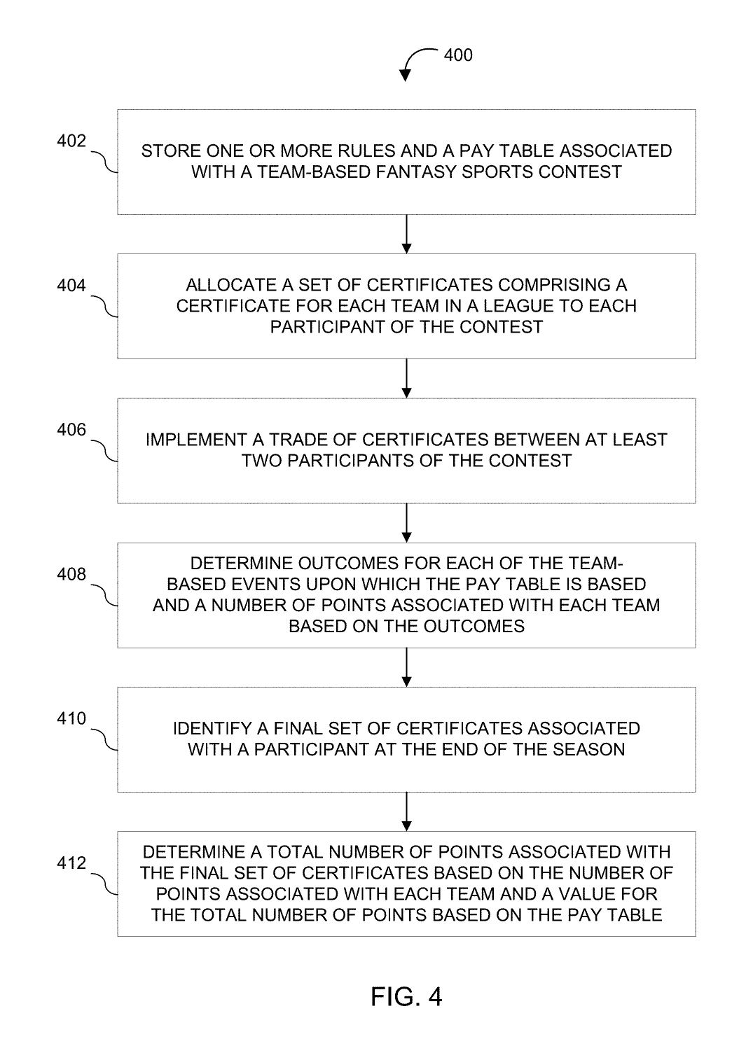

FIG. 4 depicts a flowchart of an example method 400 for creating and managing a team-based fantasy sports contest, in accordance with various embodiments. The operations of method 400 presented below are intended to be illustrative and, as such, should not be viewed as limiting. In some implementations, method 400 may be accomplished with one or more additional operations not described, and/or without one or more of the operations discussed. In some implementations, two or more of the operations may occur substantially simultaneously. The described operations may be accomplished using some or all of the system components described herein.

In an operation 402, method 400 may include storing one or more rules and a pay table associated with a team-based fantasy sports contest. In various implementations, the one or more rules may indicate that each participant in a contest is to start the season with a set of certificates that includes a single certificate representing each team in the league upon which the contest is based. In various implementations, the pay table may indicate a plurality of predetermined payouts, wherein each payout is based on a number of team-based events occurring. In some implementations, the one or more rules may include one or more rules defining who may participate in the contest, one or more rules defining whether a fee is required to participate in the contest, one or more rules defining the sport and/or league upon which the contest is based, one or more rules defining the team-based events that determine the outcome of the contest for each participant, one or more rules defining the length of a season, one or more rules associated with the allocation of certificates, one or more rules associated with trading certificates, and/or one or more other rules. The one or more rules and the pay table may be obtained from rules data datastore 216, automatically generated by the system, and/or generated based on user input received from one or more participants of the contest. In some implementations, operation 402 may be performed by a component the same as or similar to league management component 204 (shown in FIG. 2 and described herein).

In an operation 404, method 400 may include allocating a set of certificates comprising a certificate for each team in a league upon which the contest is based to each participant of the team-based fantasy sports contest. In various implementations, each participant may be allocated the same set of certificates at the start of the season. In some implementations, each participant may be allocated the set of certificates without each participant having to pay a fee. In some implementations, each participant may be allocated the set of certificates only after paying a fee to participate in the contest. The fee may be predefined by an administrative user of system 100, automatically defined based on the sport and/or league upon which the contest is based, defined by one or more participants of the contest, defined by an administrative participant of the contest, and/or otherwise defined. In some implementations, operation 404 may be performed by a component the same as or similar to certificate allocation component 206 (shown in FIG. 2 and described herein).

In an operation 406, method 400 may include implementing a trade of certificates between at least two participants of the contest. In various implementations, a trade may be implemented between a first participant and a second participant prior to the end of the season. In various implementations, a trade may be implemented only in response to receipt of an indication of assent regarding the trade from each participant involved in the trade. In various implementations, traded certificates may be reallocated to accounts associated with the receipt of the certificates in the trade. For example, a certificate traded by a first participant to a second participant may be reallocated to a user account associated with the second participant. In some implementations, trades may be implemented without payment of a fee. In some implementations, receipt of a fee from one or more participants in the trade may be required to implement the trade. In some implementations, operation 406 may be performed by a component the same as or similar to trade facilitation component 208 (shown in FIG. 2 and described herein).

In an operation 408, method 400 may include determining outcomes for each of the team-based events upon which the pay table is based and a number of points associated with each team in the league based on the outcomes. For example, a number of wins accumulated by each team during the course of the season may be determined. The number of wins accumulated by each team may be displayed to the one or more participants of a contest via a graphical user interface. For each win accumulated by a given team in the league, a corresponding number of points may be allocated to the certificate representing the given team. The number of points allocated per team-based event (e.g., win) may vary based on the period of the season in which the win occurs. For example, a greater number of points may be allocated for wins during the postseason that wins during the regular season. In some implementations, operation 408 may be performed by a component the same as or similar to outcome determination component 210 (shown in FIG. 2 and described herein).

In an operation 410, method 400 may include identifying, at the end of the season, a final set of certificates associated with a participant of the team-based fantasy sports contest. In various implementations, the final set of certificates associated with each participant may be different based on one or more trades between the one or more participants of the team-based fantasy sports contest. In some implementations, operation 410 may be performed by a component the same as or similar to outcome determination component 210 (shown in FIG. 2 and described herein).

In an operation 412, method 400 may include determining a total number of points associated with the final set of certificates based on the number of points associated with each team represented by the final set of certificates and determining a value for the total number of points based on the pay table. In various implementations, the total number of points associated with the final set of certificates may represent the cumulative team-based event totals for the teams represented by the set of certificates. For example, for each win accumulated during the regular season by a given team, each certificate representing the given team may be allocated one (1) point. In some implementations, the number of points allocated to each certificate may be greater for each win accumulated during the postseason than for each win accumulated during the regular season. In various implementations, the value for the total number of points associated with the final set of certificates for a given participant may represent a payout for the given participant. The value may be determined by comparing the total number of points to a pay table associated with the contest. In some implementations, operation 412 may be performed by a component the same as or similar to outcome determination component 210 (shown in FIG. 2 and described herein).

For purposes of explanation, numerous specific details are set forth in order to provide a thorough understanding of the description. It will be apparent, however, to one skilled in the art that implementations of the disclosure can be practiced without these specific details. In some instances, modules, structures, processes, features, and devices are shown in block diagram form in order to avoid obscuring the description. In other instances, functional block diagrams and flow diagrams are shown to represent data and logic flows. The components of block diagrams and flow diagrams (e.g., modules, blocks, structures, devices, features, etc.) may be variously combined, separated, removed, reordered, and replaced in a manner other than as expressly described and depicted herein.

Certain embodiments are described herein as including logic or a number of applications, components, engines, or mechanisms. Engines may constitute either software engines (e.g., code embodied on a machine-readable medium) or hardware engines. A “hardware engine” is a tangible unit capable of performing certain operations and may be configured or arranged in a certain physical manner. In various example embodiments, one or more computer systems (e.g., a standalone computer system, a client computer system, or a server computer system) or one or more hardware engines of a computer system (e.g., a processor or a group of processors) may be configured by software (e.g., an application or application portion) as a hardware engine that operates to perform certain operations as described herein.

Reference in this specification to “one implementation”, “an implementation”, “some implementations”, “various implementations”, “certain implementations”, “other implementations”, “one series of implementations”, or the like means that a particular feature, design, structure, or characteristic described in connection with the implementation is included in at least one implementation of the disclosure. The appearances of, for example, the phrase “in one implementation” or “in an implementation” in various places in the specification are not necessarily all referring to the same implementation, nor are separate or alternative implementations mutually exclusive of other implementations. Moreover, whether or not there is express reference to an “implementation” or the like, various features are described, which may be variously combined and included in some implementations, but also variously omitted in other implementations. Similarly, various features are described that may be preferences or requirements for some implementations, but not other implementations.

The language used herein has been principally selected for readability and instructional purposes, and it may not have been selected to delineate or circumscribe the inventive subject matter. Other implementations, uses and advantages of the invention will be apparent to those skilled in the art from consideration of the specification and practice of the invention disclosed herein. The specification should be considered exemplary only, and the scope of the invention is accordingly intended to be limited only by the following claims.

1. A computer-implemented technology platform for creating and managing a season-long, team-based fantasy sports contest associated with a sports league, wherein participants in the contest each start the season with certificates representing the same set of teams and can trade the certificates, and wherein a determination is made at the end of the season as to the value of each certificate held by a participant in accordance with a predetermined pay table established before the start of the season, the technology platform comprising:
one or more physical processors programmed with computer program instructions which, when executed, cause the one or more physical processors to:
electronically store one or more rules associated with the contest, the one or more rules including rules for allocating a predetermined number of points over the course of the season based on the outcome of a known predetermined number of team-based events during the course of the season;
electronically store a pay table indicating a plurality of predetermined payouts, wherein each predetermined payout is based on a number of points;
allocate to an account of each participant in the contest, prior to the start of the season, a set of certificates comprising a single certificate for each team in the league;
implement a trade of certificates between at least a first participant and a second participant prior to the end of the season, wherein at least a first traded certificate is reallocated from the account of the first participant to the account of the second participant responsive to the trade;
determine, during the course of the season, the outcome of each of the team-based events; and
determine, at the end of the season, (i) a number of points accumulated by each certificate based on the outcome of each of the team-based events, (ii) a final set of certificates associated with the first participant, (iii) a total number of points associated with the final set of certificates, and (iv) a payout for the first participant based on the total number of points and the pay table.

2. The system of claim 1, wherein each of the team-based events comprises a win of a game during the season.

3. The system of claim 2, wherein the rules specify a number of points allocated to each certificate per win by the team associated with the certificate.

4. The system of claim 1, wherein the one or more physical processors are further caused to:
generate the pay table based on the pre-determined number of team-based events during the course of the season.

5. The system of claim 1, wherein the one or more physical processors are further caused to allocate the set of certificates to each participant of the contest responsive to a payment of a fee received from each participant of the team-based fantasy sports contest.

6. The system of claim 1, wherein the one or more physical processors are further caused to allocate the set of certificates to each participant of the contest without payment of a fee by each participant.

7. The system of claim 5, wherein the one or more physical processors are further caused to:
implement the trade of certificates between the first participant and the second participant responsive to payment of a fee for the trade.

8. The system of claim 5, wherein the one or more physical processors are further caused to:
implement the trade of certificates between the first participant and the second participant without payment of a fee for the trade.

9. The system of claim 6, wherein the one or more physical processors are further caused to:
implement the trade of certificates between the first participant and the second participant responsive to payment of a fee for the trade.

10. The system of claim 6, wherein the one or more physical processors are further caused to:
implement the trade of certificates between the first participant and the second participant without payment of a fee for the trade.

11. The system of claim 1, wherein the one or more physical processors are further caused to allocate the set of certificates to each participant of the contest for a predetermined amount of a virtual currency.

12. The system of claim 1, wherein the one or more physical processors are further caused to:
credit an account of the first participant based on the payout determined at the end of the season.

13. The system of claim 1, wherein the set of certificates are not redeemable until the end of the season.

14. The system of claim 1, wherein the one or more physical processors are further caused to:
appoint one of the participants of the contest as a first administrative participant for the contest;
appoint a second administrative participant for a second contest different from the contest, wherein the contest and the second contest are based on the same league;
generate the pay table based on first user input received from the first administrative participant; and
generate a second pay table for the second contest based on second user input received from the second administrative participant, wherein the second pay table is different than the first pay table.

15. A computer-implemented method for creating and managing a season-long, team-based fantasy sports contest associated with a sports league, wherein participants in the contest each start the season with certificates representing the same set of teams and can trade the certificates, and wherein a determination is made at the end of the season as to the value of each certificate held by a participant in accordance with a predetermined pay table established before the start of the season, the method being implemented on a computer system having one or more physical processors programmed with computer program instructions which, when executed, perform the method, the method comprising:
electronically storing, by the computer system, one or more rules associated with the contest, the one or more rules including rules for allocating a predetermined number of points over the course of the season based on the outcome of a known predetermined number of team-based events during the course of the season;
electronically storing, by the computer system, a pay table indicating a plurality of predetermined payouts, wherein each predetermined payout is based on a number of points;
allocating, by the computer system, to an account of each participant in the contest, prior to the start of the season, a set of certificates comprising a single certificate for each team in the league;
implementing, by the computer system, a trade of certificates between at least a first participant and a second participant prior to the end of the season, wherein at least a first traded certificate is reallocated from the account of the first participant to the account of the second participant responsive to the trade;
determining, by the computer system during the course of the season, the outcome of each of the team-based events; and
determining, by the computer system at the end of the season, (i) a number of points accumulated by each certificate based on the outcome of each of the team-based events, (ii) a final set of certificates associated with the first participant, (iii) a total number of points associated with the final set of certificates, and (iv) a payout for the first participant based on the total number of points and the pay table.

16. The method of claim 15, wherein each of the team-based events comprises a win of a game during the season.

17. The method of claim 16, wherein the rules specify a number of points allocated to each certificate per win by the team associated with the certificate.

18. The method of claim 15, the method further comprising:
generating, by the computer system, the pay table based on the pre-determined number of team-based events during the course of the season.

19. The method of claim 15, the method further comprising:
allocating, by the computer system, the set of certificates to each participant of the contest responsive to a payment of a fee received from each participant of the team-based fantasy sports contest.

20. The method of claim 15, the method further comprising:
allocating, by the computer system, the set of certificates to each participant of the contest without payment of a fee by each participant.

21. The method of claim 19, the method further comprising:
implementing, by the computer system, the trade of certificates between the first participant and the second participant responsive to payment of a fee for the trade.

22. The method of claim 19, the method further comprising:
implementing, by the computer system, the trade of certificates between the first participant and the second participant without payment of a fee for the trade.

23. The system of claim 20, the method further comprising:
implementing, by the computer system, the trade of certificates between the first participant and the second participant responsive to payment of a fee for the trade.

24. The method of claim 20, the method further comprising:
implementing, by the computer system, the trade of certificates between the first participant and the second participant without payment of a fee for the trade.

25. The method of claim 15, the method further comprising:
allocating, by the computer system, the set of certificates to each participant of the contest for a predetermined amount of a virtual currency.

26. The method of claim 15, the method further comprising:
crediting, by the computer system, an account of the first participant based on the payout determined at the end of the season.

27. The method of claim 15, wherein the set of certificates are not redeemable until the end of the season.

28. The method of claim 15, the method further comprising:
appointing, by the computer system, one of the participants of the contest as a first administrative participant for the contest;
appointing, by the computer system, a second administrative participant for a second contest different from the contest, wherein the contest and the second contest are based on the same league;
generating, by the computer system, the pay table based on first user input received from the first administrative participant; and
generating, by the computer system, a second pay table for the second contest based on second user input received from the second administrative participant, wherein the second pay table is different than the first pay table.

29. The system of claim 1, wherein the rules specify one or more time periods in which certificates may not be traded, wherein the one or more physical processors are further caused to:
receive a request to trade a certificate from a participant in the contest; and
restrict the trade from occurring based on the rules.

30. The method of claim 15, wherein the rules specify one or more time periods in which certificates may not be traded, the method further comprising:
receiving, by the compute system, a request to trade a certificate from a participant in the contest; and
restricting, by the computer system, the trade from occurring based on the rules.
